(19) United States
(12) Patent Application Publication
(10) Pub. No.: US 2026/0321466 A1
(43) Pub. Date: Oct. 15, 2026

(54) SOFT MAGNETIC NANOPARTICLE AGGREGATE AND MANUFACTURING METHOD OF THE SAME

(71) Applicants: DENSO CORPORATION, Kariya-city (JP); TOHOKU UNIVERSITY, Sendai-shi (JP)

(72) Inventors: Eiji WATANABE, Kariya-city (JP); Hiroaki KURA, Kariya-city (JP); Tomoyuki OGAWA, Sendai-shi (JP); Kazuhiro OGAWA, Sendai-shi (JP); Yuji ICHIKAWA, Sendai-shi (JP); Hiroki SAITO, Sendai-shi (JP)

(21) Appl. No.: 19/640,051

(22) Filed: Apr. 6, 2026

Related U.S. Application Data
(63) Continuation of application No. PCT/JP2023/037282, filed on Oct. 13, 2023.

(51) Int. Cl. H01F 1/00; B22F 1/054; B22F 1/08; B22F 1/142; B22F 1/16; B22F 9/00; B22F 9/04; H01F 1/20

(52) U.S. Cl. CPC H01F 1/0045; B22F 1/054; B22F 1/08; B22F 1/142; B22F 1/16; B22F 9/002; B22F 9/04; H01F 1/20; B22F 2301/35; B22F 2302/10; B22F 2304/054; B22F 2998/10; B22F 2999/00

(57) ABSTRACT

A soft magnetic nanoparticle aggregate includes a plurality of soft magnetic nanoparticles that are in close contact with each other, and a non-magnetic layer filled in a grain boundary phase between the plurality of soft magnetic nanoparticles. An average particle diameter of the plurality of soft magnetic nanoparticles as observed by a transmission electron microscope is 50 nm or less. A thickness of the non-magnetic layer is 4.9 nm or less. The soft magnetic nanoparticle aggregate has a coercivity, as measured by a vibrating sample magnetometer, of 71±7.1 [A/m] or less.

### CROSS REFERENCE TO RELATED APPLICATIONS

The present application is a continuation application of International Patent Application No. PCT/JP2023/037282 filed on Oct. 13, 2023 which designated the U.S. The entire disclosure of the above application is incorporated herein by reference.

### TECHNICAL FIELD

The present disclosure relates to a soft magnetic nanoparticle aggregate and a manufacturing method of the same.

### BACKGROUND

JP 2011-171495 A discloses a soft magnetic metal film composed of an alloy mainly containing Fe (iron), in which magnetically isotropic nanoparticles having a particle diameter of 3 nm or more and 10 nm or less are deposited. By setting the thickness of this soft magnetic metal film to 0.1 to 500 μm, the saturation magnetization per unit mass can be 215 [emu/g], and the coercivity can be reduced to 100 [A/m] or less, that is, 1.2 [Oe] or less, thereby achieving excellent soft magnetic properties of high saturation magnetic flux density and low coercivity.

### SUMMARY

A soft magnetic nanoparticle aggregate according to one aspect of the present disclosure includes a plurality of soft magnetic nanoparticles that are in close contact with each other, and a non-magnetic layer filled in a grain boundary phase between the plurality of soft magnetic nanoparticles. An average particle diameter of the plurality of soft magnetic nanoparticles as observed by a transmission electron microscope may be 50 nm or less. A thickness of the non-magnetic layer may be 4.9 nm or less. A coercivity of the soft magnetic nanoparticle aggregate as measured by a vibrating sample magnetometer may be 71±7.1 [A/m] or less.

### BRIEF DESCRIPTION OF DRAWINGS

FIG. 1 is a cross-sectional view of a soft magnetic nanoparticle aggregate according to a first embodiment of the present disclosure;

FIG. 2 is a flowchart illustrating a manufacturing method of the soft magnetic nanoparticle aggregate;

FIG. 3A is a schematic cross-sectional view of a single soft magnetic nanoparticle;

FIG. 3B is a schematic cross-sectional view showing a state in which a surface of the single soft magnetic nanoparticle is coated with a non-magnetic material;

FIG. 3C is a schematic cross-sectional view of a granulated body;

FIG. 3D is a schematic cross-sectional view of an amorphous bulk body formed on a substrate;

FIG. 3E is a schematic cross-sectional view of a soft magnetic nanoparticle aggregate formed on a substrate;

FIG. 4 is a transmission electron microscope (TEM) image showing a state in which a surface of a soft magnetic nanoparticle is coated with a non-magnetic material;

FIG. 5 is a diagram illustrating formation of an amorphous bulk body using a cold spray (hereinafter referred to as “CS”) apparatus;

FIG. 6 is a photograph showing an external appearance of a soft magnetic nanoparticle aggregate;

FIG. 7A is a magnetic characteristic diagram showing a change in saturation magnetic flux density in response to a change in a magnetic field;

FIG. 7B is a graph showing coercivity;

FIG. 8 is a diagram showing a relationship between hydrogen heat treatment temperature and coercivity; and

FIG. 9 is a diagram showing a TEM image.

### DETAILED DESCRIPTION

In a soft magnetic nanoparticle aggregate, by densely packing soft magnetic nanoparticles, a saturation magnetic flux density can be increased and coercivity can be reduced, thereby improving soft magnetic properties.

However, due to the large specific surface area of nanoparticles, friction and electrostatic charging occur between the particles, which hinders close contact between the particles and makes it difficult to form a soft magnetic nanoparticle aggregate with high density. Heat treatment can be performed to increase the density, but when heat treatment is carried out at high temperatures, the particle size becomes coarse and the soft magnetic properties deteriorate, making it impossible to obtain a soft magnetic nanoparticle aggregate with high density while achieving excellent soft magnetic properties.

On the other hand, even if the soft magnetic nanoparticles are simply densified, if there is electrical contact between the particles, eddy currents increase in proportion to the particle size, resulting in eddy current losses. It is known that eddy current losses can be reduced by providing a non-magnetic layer on the surface of the soft magnetic nanoparticles. However, in such cases, a thick non-magnetic layer covers the entire surface of the soft magnetic nanoparticles. As a result, the proportion of the actual soft magnetic material within the soft magnetic nanoparticles decreases, making it difficult to achieve a high density of the soft magnetic material, and thus the magnetic flux density per unit volume is reduced. Therefore, it is difficult to obtain excellent soft magnetic properties.

A soft magnetic nanoparticle aggregate according to one aspect of the present disclosure includes a plurality of soft magnetic nanoparticles in close contact with each other, and a non-magnetic layer filled in a grain boundary phase between the plurality of soft magnetic nanoparticles. An average particle diameter of the plurality of soft magnetic nanoparticles as observed by a transmission electron microscope is 50 nm or less. A thickness of the non-magnetic layer is 4.9 nm or less. A coercivity of the soft magnetic nanoparticle aggregate, measured by a vibrating sample magnetometer, is 71±7.1 [A/m] or less.

Since the particle diameter of the soft magnetic nanoparticles is set to 50 nm or less in this manner, an increase in coercivity is suppressed. Additionally, since the thickness of the non-magnetic layer is reduced to 4.9 nm or less, even if the soft magnetic nanoparticles are partially covered by the non-magnetic layer, uncovered portions allow adjacent soft magnetic nanoparticles to be in close contact, resulting in a high density of soft magnetic nanoparticles within the aggregate, even in the presence of the non-magnetic layer. As a result, high saturation magnetic flux density can be achieved. Thus, with such a configuration, it becomes possible to achieve a low coercivity of 71 [A/m] or less, enabling the formation of a soft magnetic nanoparticle aggregate that exhibits excellent soft magnetic properties, namely, high saturation magnetic flux density and low coercivity.

A manufacturing method of a soft magnetic nanoparticle aggregate according to another aspect of the present disclosure includes: preparing a plurality of soft magnetic nanoparticles; forming composite soft magnetic nanoparticles by coating a surface of each of the plurality of soft magnetic nanoparticles with a non-magnetic material; forming an amorphous bulk body by amorphizing the plurality of soft magnetic nanoparticles contained in the composite soft magnetic nanoparticles, and forming the soft magnetic nanoparticle aggregate in which adjacent soft magnetic nanoparticles among the plurality of soft magnetic nanoparticles are in close contact with each other, and a non-magnetic layer composed of the non-magnetic material that is thermally decomposed is disposed in a grain boundary phase between the soft magnetic nanoparticles by thermally decomposing the non-magnetic material contained in the amorphous bulk body through heat treatment and desorbing a portion of the non-magnetic material.

By the manufacturing method described above, the soft magnetic nanoparticle aggregate can be obtained. The soft magnetic nanoparticle aggregate thus obtained is in a state where the soft magnetic nanoparticles are densely packed in close contact with each other, with only a thin non-magnetic layer formed in a grain boundary phase between the soft magnetic nanoparticles. Accordingly, both high saturation magnetic flux density and low coercivity can be achieved, making it possible to obtain a soft magnetic nanoparticle aggregate with excellent soft magnetic properties.

Embodiments of the present disclosure will be described below with reference to the drawings. In the following embodiments including other embodiments to be described below, the same or equivalent components will be described with the same reference numerals.

### First Embodiment

A soft magnetic nanoparticle aggregate according to the present embodiment will be described below. First, the structure of the soft magnetic nanoparticle aggregate will be described.

### <Structure of the Soft Magnetic Nanoparticle Aggregate>

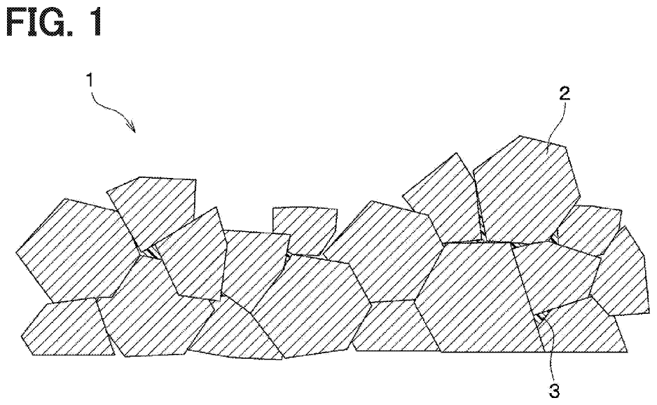

A soft magnetic nanoparticle aggregate 1 shown in FIG. 1 is formed by densely aggregating a plurality of soft magnetic nanoparticles 2, that is, fine particles of a soft magnetic material having a nano-sized particle diameter. More specifically, the soft magnetic nanoparticle aggregate 1 has a structure in which the soft magnetic nanoparticles 2 are densely packed, with adjacent soft magnetic nanoparticles 2 being in contact with each other, and a non-magnetic layer 3 is filled in gaps between the soft magnetic nanoparticles 2. In other words, the non-magnetic layer 3 is disposed in a grain boundary phase that forms a boundary of the respective soft magnetic nanoparticle 2. Since the respective soft magnetic nanoparticles 2 are in a state of high-density close contact, the gaps between the soft magnetic nanoparticles 2 are small, and the non-magnetic layer 3 is disposed within these small gaps.

The soft magnetic nanoparticles 2 may be composed of any soft magnetic material, but it is preferable to use a material with excellent soft magnetic properties. For example, the soft magnetic nanoparticles 2 may be composed of pure iron nanoparticles consisting only of Fe (iron). Pure iron refers to high-purity iron composed of iron with a high degree of purity, and higher purity is preferable. In particular, it is preferable that the soft magnetic nanoparticles 2 are composed of pure iron with a purity of approximately 99.9% or higher, consisting only of Fe, which is referred to as high-purity iron. As shown in FIG. 1, although the soft magnetic nanoparticles 2 have random crystal shapes, the soft magnetic nanoparticles 2 are densely packed within the soft magnetic nanoparticle aggregate 1, with adjacent particles being in close contact with each other.

A particle diameter of the soft magnetic nanoparticles 2 is 4 to 50 nm, and preferably 6 to 20 nm. When the soft magnetic nanoparticles 2 are single-domain single particles, coercivity tends to increase with larger particle diameters. Therefore, a smaller particle diameter is preferable. On the other hand, from a practical standpoint, a larger particle diameter is preferable.

Furthermore, when manufacturing the soft magnetic nanoparticle aggregate 1 by the manufacturing method described later, the particle diameter of the soft magnetic nanoparticles 2 contained in the soft magnetic nanoparticle aggregate 1 can be made 20 nm or less. The soft magnetic nanoparticles 2 with a particle diameter of 20 nm or less exhibit low coercivity, and the coercivity can be set to 71±7.1 [A/m], that is, 0.9±0.09 [Oe] or less. The coercivity is a value measured using a vibrating sample magnetometer. The coercivity of 71 [A/m], that is, 0.9 [Oe] or less, can be obtained. However, since a measurement error of about 10% may occur, the value is expressed in consideration of the measurement error. On the other hand, while a smaller particle diameter of the soft magnetic nanoparticles 2 can result in lower coercivity, in experiments the minimum particle diameter was about 4±0.5 nm. However, it is difficult to make the particle diameter uniform at about 4 nm, whereas soft magnetic nanoparticles 2 including those having a particle diameter of 6±0.5 nm or more can be obtained relatively easily. The particle diameter is the value of the average particle diameter observed by a transmission electron microscope. However, since a measurement error of about 0.5 nm may occur, the value is expressed in consideration of the measurement error.

The preferred range for the particle diameter of the soft magnetic nanoparticles 2 is set to 6 to 20 nm. This range is more preferable if all of the soft magnetic nanoparticles 2 have particle diameters of 6 to 20 nm. However, it does not necessarily mean that particles with diameters less than 6 nm or greater than 20 nm are excluded. It is sufficient if the average particle diameter falls within the range of 6 to 20 nm. However, the maximum particle diameter of the soft magnetic nanoparticles 2 contained in the soft magnetic nanoparticle aggregate 1 should be 50 nm or less, and it is preferable that all particles are 20 nm or less.

The density of the soft magnetic nanoparticles 2 within the soft magnetic nanoparticle aggregate 1, that is, the ratio of the volume of the soft magnetic nanoparticles 2 to the volume of the soft magnetic nanoparticle aggregate 1, is preferably as high as possible. As described above, when the soft magnetic nanoparticles 2 are pure iron nanoparticles and the non-magnetic layer 3 is an organic substance, particularly oleylamine or a decomposition product generated by thermally decomposing oleylamine, the density of the soft magnetic nanoparticles 2 within the soft magnetic nanoparticle aggregate 1 can be increased to a high density, for example, 97%.

The non-magnetic layer 3 enters the gaps between the soft magnetic nanoparticles 2 and covers the surfaces of the soft magnetic nanoparticles 2. In other words, the non-magnetic layer 3 is provided so as to cover the surfaces of portions of the soft magnetic nanoparticles 2 that are not in contact with adjacent soft magnetic nanoparticles 2. The non-magnetic layer 3 may be arranged so as to cover all gaps between the soft magnetic nanoparticles 2, or may cover the surfaces of the soft magnetic nanoparticles 2 within the gaps such that spaces remain inside the non-magnetic layer 3.

The non-magnetic layer 3 is composed of an organic substance or a decomposition product such as a carbide. For example, when the non-magnetic layer 3 is a carbide, the non-magnetic layer 3 is formed by thermally decomposing a non-magnetic material 10 described later. As an example, a liquid containing the non-magnetic material 10 composed of an organic substance such as resin is prepared, the soft magnetic nanoparticles 2 are dispersed in this solution, the solution is then dried, and furthermore, the non-magnetic material 10 is thermally decomposed, thereby forming the non-magnetic layer 3. In this case, the organic substance constituting the non-magnetic material 10 is thermally decomposed to form a carbide, and the non-magnetic layer 3 is formed from the carbide.

As described above, since the soft magnetic nanoparticles 2 are densely packed in close contact with each other, the gaps between the soft magnetic nanoparticles 2 are small, and the thickness of the non-magnetic layer 3 is also reduced to 4.9 nm or less, for example, as thin as 1.1 nm. Therefore, even if the soft magnetic nanoparticles 2 are partially covered by the non-magnetic layer 3, the density of the non-magnetic layer 3 within the soft magnetic nanoparticle aggregate 1 remains low, while the density of the soft magnetic nanoparticles 2 is high.

As described above, the soft magnetic nanoparticle aggregate 1 of the present embodiment is composed of an aggregate of a large number of soft magnetic nanoparticles 2 and the non-magnetic layers 3 disposed in the gaps between the soft magnetic nanoparticles 2. The soft magnetic nanoparticles 2, although having random crystal shapes, are densely packed in a state in which they are adjacent to one another in the soft magnetic nanoparticle aggregate 1. Therefore, high saturation magnetic flux density can be achieved.

Furthermore, since the soft magnetic nanoparticles 2 are densely packed, direct interactions between the particles are promoted, making it possible to reduce the effective magnetic anisotropy and thereby further decrease the coercivity.

The coercivity is a value indicating efficiency or loss in soft magnetic properties, and the smaller the value, the more excellent the soft magnetic properties. In addition, the saturation magnetic flux density refers to the magnetic flux density when the soft magnetic nanoparticles 2 are magnetically saturated, and the higher the value, the better the soft magnetic properties. The saturation magnetic flux density, for example, is measured using a vibrating sample magnetometer. The higher the packing density of the soft magnetic nanoparticles 2, the higher the saturation magnetic flux density per unit volume can be achieved.

Furthermore, in the soft magnetic nanoparticle aggregate 1 of the present embodiment, the soft magnetic nanoparticles 2 are densely packed, while their surfaces are covered by the non-magnetic layer 3. As a result, electrical contact between the particles is suppressed, making it possible to reduce eddy current losses.

On the other hand, in the case where the surfaces of the soft magnetic nanoparticles 2 are covered with the non-magnetic layer 3, if the non-magnetic layer 3 is too thick, it becomes impossible to achieve a high packing density of the soft magnetic nanoparticles 2, resulting in a decrease in the magnetic flux density per unit volume. Therefore, there is a trade-off in that attempting to reduce eddy current losses leads to a decrease in the soft magnetic properties of the soft magnetic nanoparticle aggregate 1. In particular, in the case of nanoparticles, their large specific surface area leads to a more pronounced decrease in magnetic flux density.

However, in the soft magnetic nanoparticle aggregate 1 of the present embodiment, the non-magnetic layer 3 can be made thin, that is, 4.9 nm or less, for example 1.1 nm, and the density of the non-magnetic layer 3 can be reduced. Therefore, the soft magnetic nanoparticles 2 can be densely packed, and a decrease in magnetic flux density per unit volume can be suppressed. Therefore, both high saturation magnetic flux density and low coercivity can be achieved, making it possible to obtain the soft magnetic nanoparticle aggregate 1 with excellent soft magnetic properties.

### <Manufacturing Method of Soft Magnetic Nanoparticle Aggregate 1>

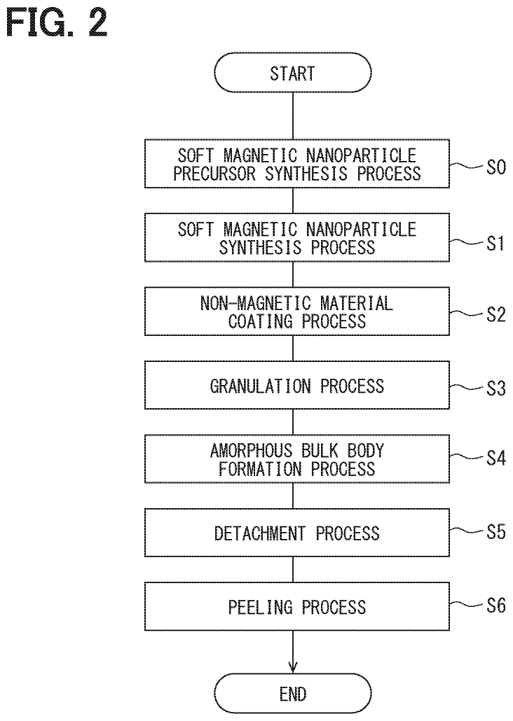

Next, a manufacturing method of the soft magnetic nanoparticle aggregate described above will be described. The soft magnetic nanoparticle aggregate 1 of the present embodiment is manufactured through the processes shown in the manufacturing flow of FIG. 2. Specifically, a soft magnetic nanoparticle precursor synthesis process at S0, a soft magnetic nanoparticle synthesis process at S1, a non-magnetic material coating process at S2, a granulation process at S3, an amorphous bulk body formation process at S4, a desorption process at S5, and a peeling process at S6 shown in FIG. 2 are carried out.

In the soft magnetic nanoparticle precursor synthesis process at S0, a precursor serving as a raw material for the soft magnetic nanoparticles 2 is synthesized. The raw material of the soft magnetic nanoparticles 2 is mixed with a raw material of the non-magnetic material 10. Specifically, Fe(CO)₅ and oleylamine are mixed at a temperature of 20 to 40 °C. The mixing ratio of the soft magnetic nanoparticles 2 to oleylamine may be set optionally. However, for example, the molar ratio of oleylamine to the soft magnetic nanoparticles 2 may be set to 1:2.5.

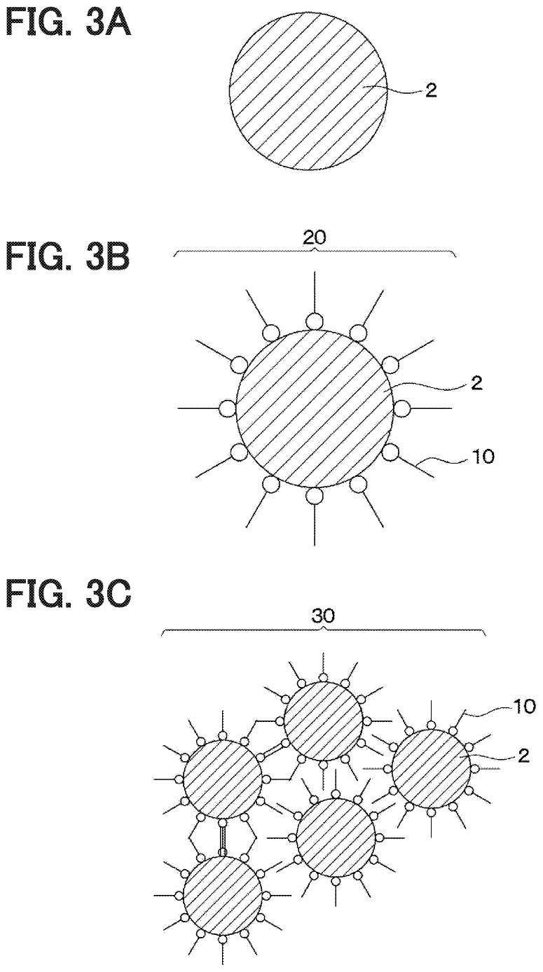

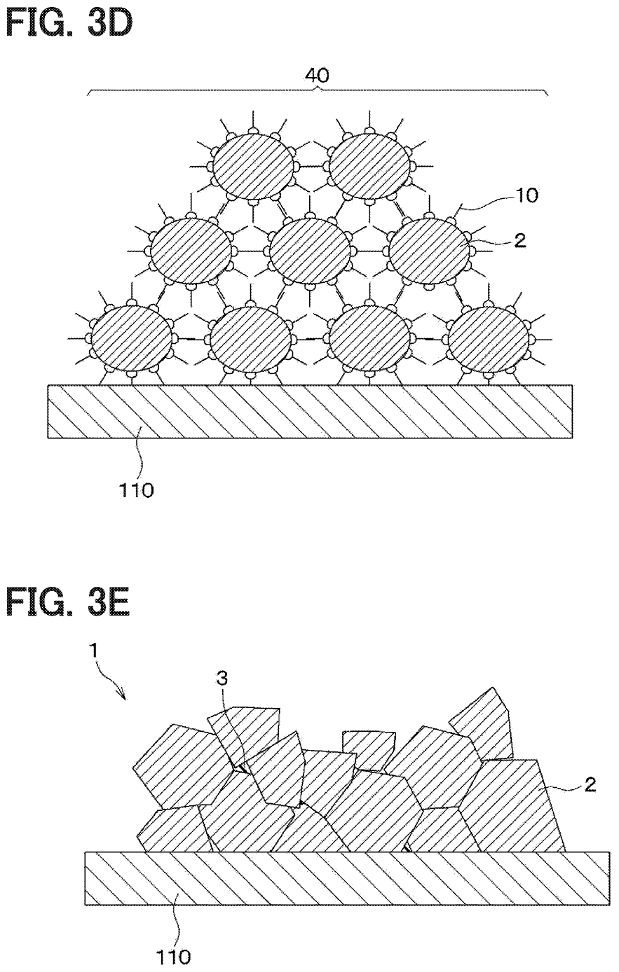

In the soft magnetic nanoparticle synthesis process at S1, the precursor is heated to produce the soft magnetic nanoparticles 2. Fe(CO)₅ is iron pentacarbonyl, a precursor of an iron compound that exists as a liquid under standard conditions and is synthesized, for example, from carbon monoxide and fine iron powder. When the liquid Fe(CO)₅ is heated while being stirred with a propeller, pure iron nanoparticles that constitute the soft magnetic nanoparticles 2 are produced. At this time, the soft magnetic nanoparticles 2 have a crystalline shape that is, for example, spherical as shown in FIG. 3A, and the particle diameter is approximately 2 to 10 nm. The temperature during stirring may be set optionally. However, the temperature is controlled at 30 °C or higher, where thermal decomposition begins, and at 200 °C or lower, where particle growth of the soft magnetic nanoparticles 2 does not occur, and more preferably at 130 °C or lower. For the soft magnetic nanoparticles 2, it has been confirmed that changes in temperature up to 200 °C do not significantly affect the saturation magnetic flux density, but when the temperature exceeds 200 °C, the coercivity increases (see M. Kamata et al., J. Magn. Soc. Jpn, 36, 309 (2012)). Therefore, by setting the temperature during stirring to 200 °C or lower, for example, 70±3 °C, it is possible to maintain a high saturation magnetic flux density while suppressing an increase in coercivity.

In this specification, the particle diameter is defined as the average value of thirty particles observed by TEM. If the particles are spherical, the diameter is used; for spindle-shaped particles with both major and minor axes, or for irregularly shaped particles, the area is determined by image processing, and the diameter of a circle with the same area is regarded as the particle diameter. As described above, when the soft magnetic nanoparticles 2 in this process are pure iron nanoparticles, they take a spherical form, and their diameter is considered to be the particle diameter.

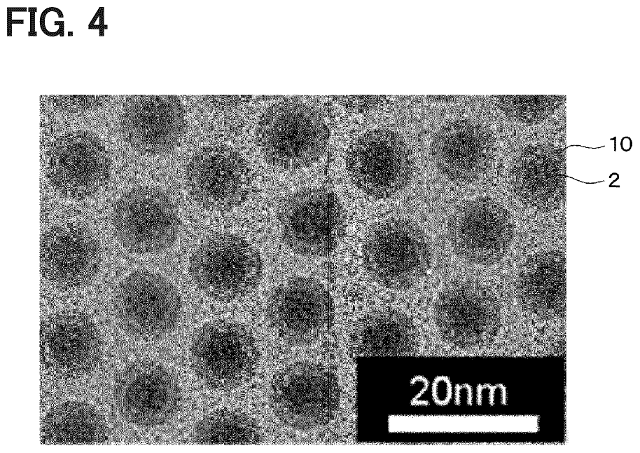

In the non-magnetic material coating process at S2, as shown in FIG. 3B, the composite soft magnetic nanoparticles 20 are formed by coating the surface of the soft magnetic nanoparticles 2 with the non-magnetic material 10. Specifically, as shown in FIG. 4, the soft magnetic nanoparticles 2 are mixed into a liquid containing the non-magnetic material 10. As a result, the non-magnetic material 10 adheres to the surface of the soft magnetic nanoparticles 2, and the non-magnetic material 10 is arranged in the “grain boundary phase” at the boundaries between the soft magnetic nanoparticles 2. At this time, the thickness of the non-magnetic material 10 is approximately 1 to 3 nm, and preferably about 1 to 2 nm.

The liquid containing the non-magnetic material 10 may be a solution in which the non-magnetic material 10 is dissolved in a solvent, or, if the non-magnetic material 10 is a liquid, the non-magnetic material 10 alone may be used. Of course, even if the non-magnetic material 10 is a liquid, a solution in which the non-magnetic material 10 is dissolved in a solvent may also be used as the liquid containing the non-magnetic material 10. By preparing a solution in which the non-magnetic material 10 is dissolved in a solvent, the concentration of the non-magnetic material 10 in the solution can be adjusted. In the case where a solution in which the non-magnetic material 10 is dissolved in a solvent is used, for example, a solvent having a boiling point lower than the temperature at which the non-magnetic material 10 thermally decomposes under atmospheric pressure or a specific ambient pressure (hereinafter referred to as the thermal decomposition temperature) is used.

For example, oleylamine (CH₃(CH₂)₇CH=CH(CH₂)₈NH₂), which serves as a surfactant, is used as the non-magnetic material 10. Regarding the liquid containing the non-magnetic material 10, since oleylamine itself is a liquid, it is possible to use oleylamine as is. However, a solution in which oleylamine is dissolved in toluene as a solvent is used. The solution in which oleylamine is dissolved in toluene is prepared, and the soft magnetic nanoparticles 2 are mixed into this solution and heated. As a result, oleylamine, serving as the non-magnetic material 10, adheres to the surface of the soft magnetic nanoparticles 2, thereby obtaining a structure in which the surface of the soft magnetic nanoparticles 2 is coated with oleylamine. Since toluene is volatile, toluene may evaporate during this process. However, it is acceptable for all of the toluene to be evaporated and removed, or for a portion of the toluene to remain.

The mixing of the soft magnetic nanoparticles 2 with oleylamine and the like is also carried out while stirring with a propeller, and the heating temperature is set to 200 °C or less, for example, 70±1 °C. In addition, the mixing ratio of the soft magnetic nanoparticles 2 to oleylamine may be set optionally. For example, the molar ratio of oleylamine to the volume of the soft magnetic nanoparticles 2 may be set to 1:2.5.

The thickness of the non-magnetic material 10 is determined by the volume of oleylamine relative to the volume of the soft magnetic nanoparticles 2, or in other words, the surface area, of the soft magnetic nanoparticles 2. Therefore, by appropriately adjusting the mixing ratio of the soft magnetic nanoparticles 2 and oleylamine, the thickness of the non-magnetic material 10 can be set to a desired value. If the non-magnetic material 10 is too thick, the densification of the soft magnetic nanoparticles 2 in the soft magnetic nanoparticle aggregate 1 that is finally formed will be inhibited. Therefore, it is preferable that the thickness of the non-magnetic material 10 in this process is about 1 to 2 nm as described above.

In the granulation process at S3, after drying the composite soft magnetic nanoparticles 20, whose surfaces are coated with the non-magnetic material 10, the dried particles are granulated to form a granulated body 30, which is an aggregate of the composite soft magnetic nanoparticles 20 as shown in FIG. 3C. At this time, the size of the granulated body 30 may be set optionally. However, it is preferable to make the size uniform for ease of handling in subsequent processes.

When drying the composite soft magnetic nanoparticles 20, heat treatment is performed to promote drying. Regarding the heat treatment, it is preferable to perform vacuum heat treatment, in which the composite soft magnetic nanoparticles 20 are placed in a heat treatment apparatus and heated under a reduced pressure atmosphere, preferably under vacuum, as well as hydrogen heat treatment, in which heating is carried out under a hydrogen atmosphere.

For example, heat treatment is performed using a tubular furnace as the heat treatment apparatus. For the vacuum heat treatment, the degree of vacuum is set to 1.0×10 Pa. In addition, for the hydrogen heat treatment, the flow rate of H₂ (hydrogen) is set to 400 cc/min. For both the vacuum heat treatment and the hydrogen heat treatment, the heating temperature is set to 200 °C or lower, in this case, both are set to 170 °C, but different temperatures may be used depending on the particle diameter of Fe. The duration of the vacuum heat treatment and the hydrogen heat treatment may be determined as appropriate according to the degree of dryness and may be set optionally. In this case, both treatments are performed for 5 hours each.

In addition, when forming the granulated bodies 30 of uniform size, the composite soft magnetic nanoparticles 20, after drying, are first made into small lumps, which are then broken down to obtain the granulated bodies 30 of the desired size. Specifically, the composite soft magnetic nanoparticles 20 after drying are pressed with a hand press to form pellets, that is, small lumps. These pellets are formed by densely packing a large number of soft magnetic nanoparticles 2, with each soft magnetic nanoparticle 2 being surrounded by the non-magnetic material 10. The size of the pellets may be set optionally. However, the pellets are made larger than the size of the granulated bodies 30 that are ultimately desired.

Then, although not shown in the drawings, the pellets are crushed using a mortar to produce the granulated bodies 30 of uniform size, such as a particle diameter of about 20 to 200 μm, which are easy to handle in subsequent processes.

In the amorphous bulk body forming process at S4, the granulated bodies 30 are plastically deformed to amorphize the crystals of the soft magnetic nanoparticles 2 in the granulated bodies 30. For example, the crystals of the soft magnetic nanoparticles 2 can be amorphized using a CS apparatus based on the CS method.

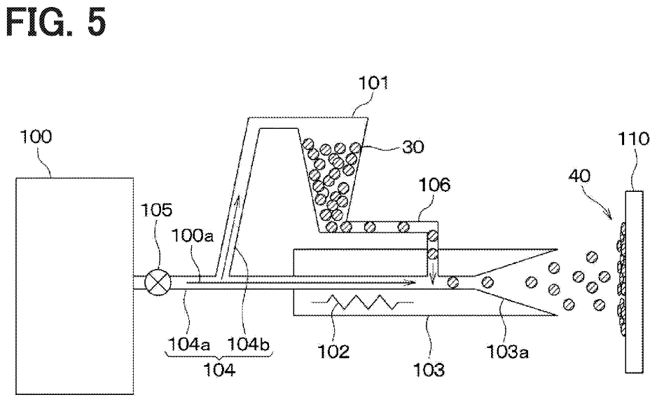

As shown in FIG. 5, the CS apparatus is equipped with a high-pressure gas source 100, a powder supply source 101, a preheater 102, and a CS gun 103.

The high-pressure gas source 100 supplies a carrier gas 100a at high pressure. In this case, an inert atmosphere CS apparatus is used. For example, N₂ (nitrogen) gas with a gas purity of 99.999% or higher is used as the carrier gas 100a, with the gas temperature set to 100 °C and the gas pressure set to 0.5 MPa. In addition, a gas supply line 104 is connected to the high-pressure gas source 100, and by controlling a valve 105 provided in the gas supply line 104, the supply and stoppage of the carrier gas 100a can be regulated. The gas supply line 104 is branched into two lines. One branch line 104a is connected to the CS gun 103, while the other branch line 104b is connected to the powder supply source 101.

The powder supply source 101 contains the granulated bodies 30 that have been size-controlled in the granulation process, and is connected to the high-pressure gas source 100 via the branch line 104b and to the CS gun 103 via a discharge line 106. Then, based on the high-pressure carrier gas 100a supplied from the branch line 104b, the powder supply source 101 pushes the particles of the granulated bodies 30 contained in the powder supply source 101 into the discharge line 106 and supplies them to the CS gun 103.

The preheater 102 heats the carrier gas 100a to a predetermined temperature, for example, 100 °C. The preheater 102 is installed within the CS gun 103 and heats the gas supply line 104, but the preheater 102 may also be arranged outside the CS gun 103.

The CS gun 103 accelerates the granulated bodies 30 to supersonic speeds by mixing them with the high-pressure carrier gas 100a supplied from the branch line 104a, and sprays them onto the substrate 110, which is installed in front of a discharge port 103a of the CS gun 103, while maintaining their solid state. As a result, when the granulated bodies 30 collide with the substrate 110, an impact force is imparted to the granulated bodies 30. When N₂ gas is used as the carrier gas 100a, the gas purity, the gas temperature, and the gas pressure are set to the above-described conditions, the material of the soft magnetic nanoparticles 2 is Fe, and the particle diameter of the granulated bodies 30 is 20 to 200 μm, the granulated bodies 30 are accelerated and ejected at a velocity of several hundred meters per second.

As a result, when the granulated bodies 30 collide with the substrate 110 and a significant impact force is generated in the particles, the crystalline state of the soft magnetic nanoparticles 2 within the composite soft magnetic nanoparticles 20 becomes amorphous, and an amorphous bulk body 40 as shown in FIG. 3D is obtained. The material of the substrate 110 may be set optionally. However, it is preferable to use a material that is different from the constituent material of the soft magnetic nanoparticles 2 in the soft magnetic nanoparticle aggregate 1 to be manufactured, and more preferably, a material with a different coefficient of linear thermal expansion. In this case, the substrate 110 is made of Cu (copper).

The magnitude of the impact force at this time is determined by parameters such as the size of the granulated bodies 30, the gas flow velocity, the side chain length of the surfactant constituting the non-magnetic material 10, and the coverage rate of the surfactant. Therefore, parameters that determine the impact force are adjusted so as to generate an impact force capable of amorphizing the crystals of the soft magnetic nanoparticles 2.

In the desorption process at S5, the non-magnetic material 10 is thermally decomposed by performing vacuum heat treatment in which the amorphous bulk body 40 is heated in at least a reduced-pressure atmosphere, preferably under vacuum, and a portion of the components of the non-magnetic material 10 is desorbed. Furthermore, in addition to heating in a reduced-pressure atmosphere, it is preferable to perform hydrogen heat treatment by heating in a hydrogen atmosphere. Through such thermal decomposition, as shown in FIG. 3E, the non-magnetic material 10 between the soft magnetic nanoparticles 2 contained in the amorphous bulk body 40 is reduced. Then, the crystal shapes of the soft magnetic nanoparticles 2 become random, forming the soft magnetic nanoparticle aggregate 1, and within the soft magnetic nanoparticle aggregate 1, the soft magnetic nanoparticles 2 are densely packed in a state where they are adjacent to each other.

For example, a tubular furnace is used as the heat treatment apparatus, and the vacuum heat treatment is performed at a vacuum degree of 1.0×10 Pa. In addition, the hydrogen heat treatment is performed with an H₂ flow rate of 400 cc/min. For both the vacuum heat treatment and the hydrogen heat treatment, the temperature is set to 200 °C or lower, in this case, both are set to 170 °C, but different temperatures may be used depending on the particle diameter. In addition, as long as the duration of the vacuum heat treatment and hydrogen heat treatment is sufficient for the crystallization of the magnetic nanoparticles, the time may be set optionally according to the degree of desorption of the non-magnetic material 10. In this case, both treatments are performed for 48 hours each.

Furthermore, when a portion of the components of the non-magnetic material 10 is desorbed by such thermal decomposition, the non-magnetic layer 3 is formed. The thickness of the non-magnetic layer 3 can be made as thin as 4.9 nm or less. The thickness of the non-magnetic layer 3 depends on the duration of the heat treatment and the thickness of the non-magnetic material 10 before desorption, and can thus be adjusted optionally. According to experiments, it was possible to achieve a thickness of at least as thin as 1.1 nm. In this way, since the thickness of the non-magnetic layer 3 can be made thin, even when the non-magnetic layer 3 is filled in the grain boundary phase between the soft magnetic nanoparticles 2, the soft magnetic nanoparticles 2 can be densely packed.

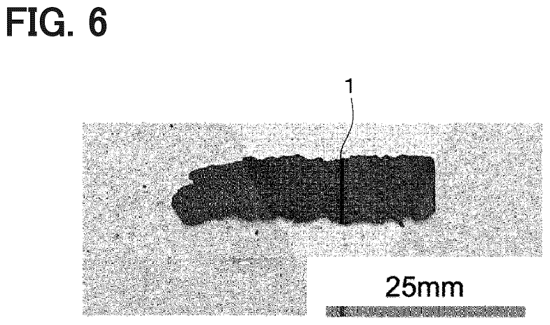

In the peeling process at S6, the soft magnetic nanoparticle aggregate 1 adhering to the surface of the substrate 110 is peeled off from the substrate 110. For example, the substrate 110 and the soft magnetic nanoparticle aggregate 1 are placed inside a cooling device and cooled. In this case, the substrate 110 and the soft magnetic nanoparticle aggregate 1 are cooled to approximately 5 °C. As a result, due to the thermal stress generated based on the difference in coefficients of linear expansion between the substrate 110 and the constituent material of the soft magnetic nanoparticles 2 in the soft magnetic nanoparticle aggregate 1, the soft magnetic nanoparticle aggregate 1 can be peeled off from the substrate 110. As a result, as shown in FIG. 6, it is possible to obtain a mass of the soft magnetic nanoparticle aggregate 1. The soft magnetic nanoparticle aggregate 1 obtained in this manner can be acquired as a mass of a large size, for example, approximately several millimeters, and as shown in FIG. 6, about 25 mm.

By means of the manufacturing method described above, the soft magnetic nanoparticle aggregate 1 can be obtained. The soft magnetic nanoparticle aggregate 1 obtained in this manner is in a state where the soft magnetic nanoparticles 2 are densely packed and adhered to each other, and only the non-magnetic layer 3 is formed thinly in the grain boundary phase between the soft magnetic nanoparticles 2. Therefore, both high saturation magnetic flux density and low coercivity can be achieved, making it possible to obtain the soft magnetic nanoparticle aggregate 1 with excellent soft magnetic properties.

In addition, the soft magnetic nanoparticle aggregate 1 is not composed solely of the soft magnetic nanoparticles 2, but has a structure in which the non-magnetic layer 3 is filled in the grain boundary phase. Therefore, the non-magnetic layer 3 can reduce the heat generated when a magnetic field is applied to the soft magnetic nanoparticle aggregate 1 at high frequencies.

In addition, the soft magnetic nanoparticle aggregate 1 manufactured through the peeling process is obtained by colliding the granulated bodies 30 onto the substrate 110, depositing the granulated bodies 30, and then thermally decomposing the deposited material. Therefore, the soft magnetic nanoparticle aggregate 1 can be formed to a greater thickness simply by adjusting the deposition thickness on the substrate 110, allowing for a thickness of several hundred micrometers or more, preferably 1000 micrometers or more. According to experiments, it was possible to obtain a soft magnetic nanoparticle aggregate 1 with a thickness of 1500 micrometers or more. In this way, since a greater thickness can be achieved, the practicality of the soft magnetic nanoparticle aggregate 1 can be enhanced. Furthermore, since the soft magnetic nanoparticle aggregate 1 can be obtained as a large-sized mass, the practicality can be further enhanced.

As a reference, comparative experiments were conducted for the case where the soft magnetic nanoparticle aggregate 1 was produced using the CS method as in the present embodiment, Comparative Example 1, in which the aggregate was produced by press molding followed by heat treatment, and Comparative Example 2, in which pure iron nanoparticles were subjected to heat treatment.

Specifically, for both the present embodiment and Comparative Example 1, the same processes were carried out up to the soft magnetic nanoparticle precursor synthesis process at S0, the soft magnetic nanoparticle synthesis process at S1, the non-magnetic material coating process at S2, and the granulation process at S3. Thereafter, different subsequent processes were employed to produce the soft magnetic nanoparticle aggregate 1. For the present embodiment, after the processes S1 to S3, as described above, the soft magnetic nanoparticle aggregate 1 was produced by carrying out the amorphous bulk formation process at S4, the desorption process at S5, and the peeling process at S6. For Comparative Example 1, after processes S0 to S3, the granulated body 30 was formed by press molding at a molding pressure of 196 kgf, under an inert atmosphere, and at room temperature of approximately 27 °C. Thereafter, the non-magnetic material 10 was thermally decomposed to produce the soft magnetic nanoparticle aggregate 1. For Comparative Example 2, after carrying out processes S0 and S1 to produce pure iron nanoparticles, a heat treatment similar to the thermal decomposition of the non-magnetic material 10 was performed.

Then, for the samples of the present embodiment and Comparative Examples 1 and 2, evaluations of the soft magnetic nanoparticles 2 were conducted. For the present embodiment and Comparative Example 1, evaluations were conducted regarding density, magnetic properties, and microstructure. For Comparative Example 2, only the magnetic properties were evaluated. The density was evaluated using the liquid displacement method. The magnetic properties were evaluated using a VSM (Vibrating Sample Magnetometer). The microstructure was evaluated using TEM.

Regarding the density, in Comparative Example 1, the value before thermal decomposition of the non-magnetic material 10 was 35%, whereas after thermal decomposition it increased to 73%. In addition, in the present embodiment, the value before thermal decomposition of the non-magnetic material 10 was 32%, whereas after thermal decomposition it increased to 97%. Based on these results, the soft magnetic nanoparticle aggregate 1 of the present embodiment achieved a high density of the soft magnetic nanoparticles 2, with the density improved by more than 60% compared to Comparative Example 1.

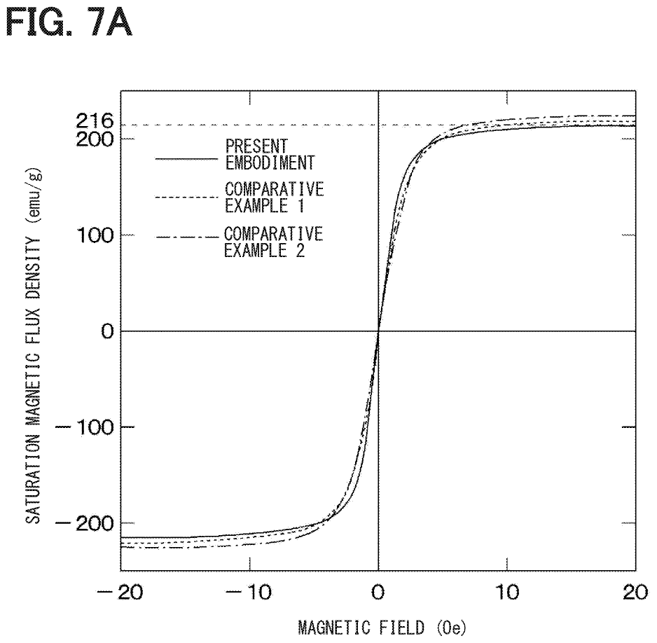

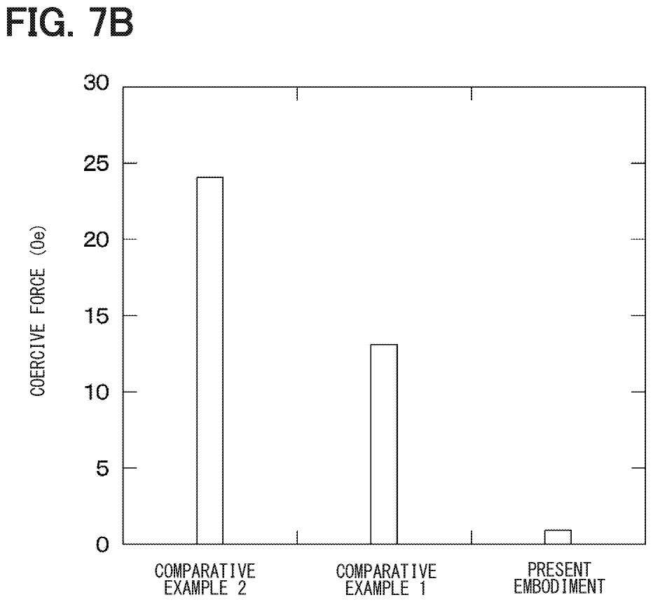

Furthermore, regarding the magnetic properties, the change in saturation magnetic flux density in response to changes in the magnetic field was examined for each of the present embodiment and Comparative Examples 1 and 2. FIG. 7A shows the results. As shown in FIG. 7A, in the case of the present embodiment, the saturation magnetic flux density was 216 [emu/g] per unit mass. When the saturation magnetic flux density is 180 [emu/g] or higher, it can be said to have a high saturation magnetic flux density. In the present embodiment, a saturation magnetic flux density of 180 [emu/g] or higher was achieved. In addition, although Comparative Example 2, which consists of pure iron nanoparticles, achieves a high saturation magnetic flux density, the present embodiment was also able to attain a saturation magnetic flux density equivalent to that of Comparative Example 2. On the other hand, coercivity, which is one of the magnetic properties, was also examined for the present embodiment as well as Comparative Examples 1 and 2, respectively. FIG. 7B shows the results. As shown in FIG. 7B, the coercivity was 24 [Oe], that is, 1900 [A/m] for Comparative Example 2, 13 [Oe], that is, 1000 [A/m] for Comparative Example 1, and 0.9 [Oe], that is, 71 [A/m] for the present embodiment. Thus, it can be seen that the soft magnetic nanoparticle aggregate 1 of the present embodiment exhibits both high saturation magnetic flux density and low coercivity, resulting in excellent magnetic properties. It should be noted that the coercivities were measured using a vibrating sample magnetometer, and since a measurement error of up to 10% may occur, for the measured value of 71 [A/m], the value in consideration of the measurement error is 71±7.1 [A/m].

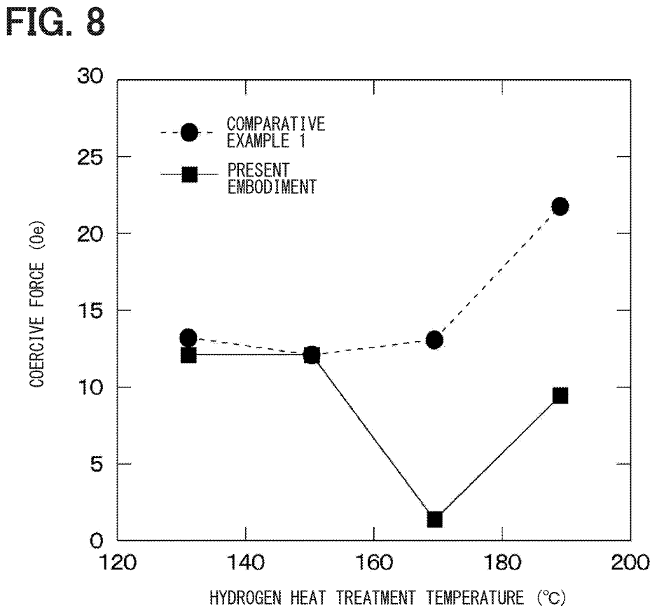

Furthermore, multiple samples of the present embodiment and Comparative Example 1, which underwent the same processes up to before the desorption process, were prepared, and their coercivities were examined by varying the hydrogen heat treatment temperature. FIG. 8 shows the results of the investigation. Here, changes in coercivity were investigated when the hydrogen heat treatment temperature was set to four different values: 130 °C, 150 °C, 170 °C, and 190 °C. As shown in FIG. 8, at any of the hydrogen heat treatment temperatures, the coercivity of the samples of the present embodiment was equal to or lower than that of the samples of Comparative Example 1. In particular, at 170 °C and 190 °C, the coercivity of the samples of the present embodiment decreased even further compared to that of the samples of Comparative Example 1. Based on these results, if the coercivity at each temperature is connected by an approximate straight line, it can be said that conducting hydrogen heat treatment at temperatures above 150 °C is effective for obtaining low coercivity.

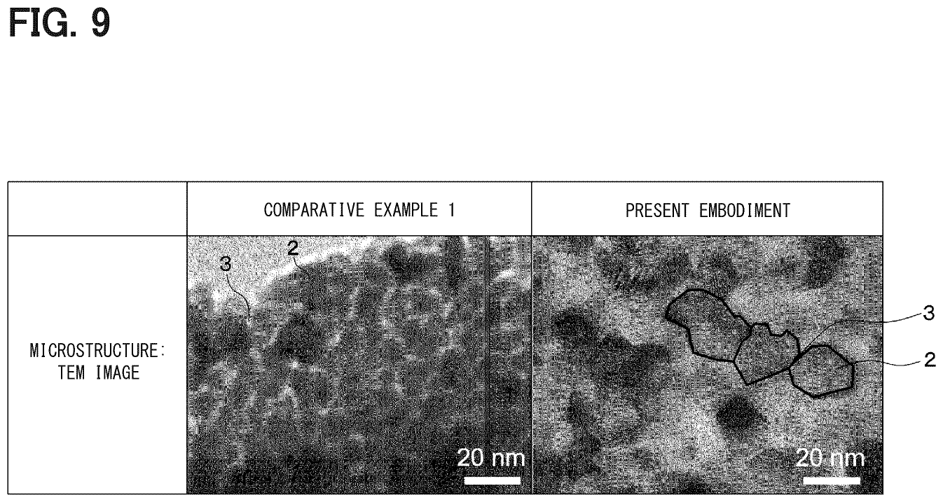

In addition, the microstructure of the present embodiment and Comparative Example 1 is as shown in the TEM images of the microstructure depicted in FIG. 9. As shown in this figure, in the case of press molding, it can be seen that the grain boundary phase between the soft magnetic nanoparticles 2 is large. This indicates that, in the case of press molding, the soft magnetic nanoparticles 2 are not densely packed. Furthermore, in the case of the present embodiment, the grain boundary phase between the soft magnetic nanoparticles 2 is reduced, and the soft magnetic nanoparticles 2 are densely packed.

As shown in Comparative Example 1 in FIG. 9, when the soft magnetic nanoparticles 2 are not densely packed and the grain boundary phase between each particle is significantly present, a reduction in coercivity due to the averaging of magnetic anisotropy does not occur.

In contrast, in the soft magnetic nanoparticle aggregate 1 of the present embodiment shown in FIG. 9, the soft magnetic nanoparticles 2 are densely packed in a state where they are adjacent to each other within the soft magnetic nanoparticle aggregate 1. In such a state, it becomes possible to reduce the effective magnetic anisotropy of the soft magnetic nanoparticle aggregate 1, thereby enabling a further reduction in coercivity.

### Other Embodiments

Although the present disclosure has been described in accordance with the above embodiments, it is not limited to those embodiments and includes various modifications and variations within the scope of equivalents. In addition, various combinations and forms, as well as other combinations and forms including only one element thereof, more elements, or fewer elements, are also intended to fall within the scope and spirit of the present disclosure.

For example, in the above embodiment, the amorphous bulk formation process is carried out using the CS method, but any other method may be used as long as it generates an impact force capable of amorphizing the crystals of the soft magnetic nanoparticles 2.

In addition, by performing the granulation process, the granulated body 30, which is an aggregate of the composite soft magnetic nanoparticles 20, is formed. This is merely one example, and if the aggregate of the composite soft magnetic nanoparticles 20 obtained in the non-magnetic material coating process is of a size that is easy to handle in subsequent processes, the granulation process does not need to be performed.

Furthermore, although the peeling process utilizing the difference in linear expansion coefficients between the substrate 110 and the soft magnetic nanoparticles 2 is performed, the soft magnetic nanoparticle aggregate 1 may also be mechanically separated from the substrate 110 using tools such as a scraper.

In each of the above-described embodiments, it goes without saying that the elements constituting the embodiments are not necessarily essential unless they are explicitly stated to be essential or are considered to be clearly essential in principle. Furthermore, in each of the above-described embodiments, when numerical values such as the number, value, quantity, or range of the constituent elements of the embodiments are mentioned, such values are not limited to those specific numbers unless they are explicitly stated to be essential or are clearly limited to specific numbers in principle.

What is claimed is:

1. A soft magnetic nanoparticle aggregate comprising:
a plurality of soft magnetic nanoparticles that are in close contact with each other; and
a non-magnetic layer filled in a grain boundary phase between the plurality of soft magnetic nanoparticles, wherein
an average particle diameter of the plurality of soft magnetic nanoparticles as observed by a transmission electron microscope is 50 nm or less,
a thickness of the non-magnetic layer is 4.9 nm or less, and
a coercivity of the soft magnetic nanoparticle aggregate as measured by a vibrating sample magnetometer is 71±7.1 [A/m] or less.

2. The soft magnetic nanoparticle aggregate according to claim 1, wherein
the plurality of soft magnetic nanoparticles are pure iron nanoparticles composed only of Fe, and
the non-magnetic layer is composed of a carbide.

3. The soft magnetic nanoparticle aggregate according to claim 1, wherein
a saturation magnetic flux density of the soft magnetic nanoparticle aggregate as measured by the vibrating sample magnetometer is 180 [emu/g] or more.

4. The soft magnetic nanoparticle aggregate according to claim 1, wherein
the average particle diameter of the plurality of soft magnetic nanoparticles as observed by the transmission electron microscope is 4 nm or more.

5. The soft magnetic nanoparticle aggregate according to claim 1, wherein
a particle diameter of the plurality of soft magnetic nanoparticles as observed by the transmission electron microscope is 6 to 20 nm.

6. A manufacturing method of a soft magnetic nanoparticle aggregate, comprising:
preparing a plurality of soft magnetic nanoparticles;
forming composite soft magnetic nanoparticles by coating a surface of each of the plurality of soft magnetic nanoparticles with a non-magnetic material;
forming an amorphous bulk body by amorphizing the plurality of soft magnetic nanoparticles contained in the composite soft magnetic nanoparticles; and
forming the soft magnetic nanoparticle aggregate in which adjacent soft magnetic nanoparticles among the plurality of soft magnetic nanoparticles are in close contact with each other, and a non-magnetic layer composed of the non-magnetic material that is thermally decomposed is disposed in a grain boundary phase between the plurality of soft magnetic nanoparticles by thermally decomposing the non-magnetic material contained in the amorphous bulk body through a heat treatment and desorbing a portion of the non-magnetic material.

7. The manufacturing method according to claim 6, further comprising
forming a granulated body as an aggregate of the composite soft magnetic nanoparticles after forming the composite soft magnetic nanoparticles, wherein
forming the amorphous bulk body includes plastically deforming the granulated body to amorphize the plurality of soft magnetic nanoparticles.

8. The manufacturing method according to claim 7, wherein
forming the amorphous bulk body includes using a cold spray apparatus to eject the granulated body onto a surface of a substrate and colliding the granulated body with the substrate to plastically deform the granulated body.

9. The manufacturing method according to claim 6, wherein
forming the soft magnetic nanoparticle aggregate includes performing the heat treatment for thermal decomposition of the non-magnetic material at a temperature of 200 °C or lower.
